(19) United States
(12) Patent Application Publication
(10) Pub. No.: US 2023/0215299 A1
(43) Pub. Date: Jul. 6, 2023

(54) DEVICE FOR MOUNTING SALES LABELS

(71) Applicants: Steven William JOHNS, Vancouver (CA); Bernard LEUNG, Markham (CA)

(72) Inventors: Steven William JOHNS, Vancouver (CA); Bernard LEUNG, Markham (CA)

(21) Appl. No.: 17/647,315

(22) Filed: Jan. 6, 2022

(51) Int. Cl. G09F 3/20; F16M 13/02

(52) U.S. Cl. CPC G09F 3/204; F16M 13/022

(57) ABSTRACT

A device for mounting sales labels is used to easily mount sales labels onto shelving systems of retail stores. The device comprises a label housing unit, one or more spring-loaded attachment legs and a lever. The device has a first disengaged position where the device may be easily mounted onto a channel on the shelving system and a second engaged position where the device is locked in place on the channel.

### FIELD OF THE INVENTION

This invention relates generally to attachment devices used to secure accessories onto a piece of equipment or other member. More particularly, the invention relates to attachment devices used to mount sales labels onto shelving systems with channels for labels.

### BACKGROUND OF THE INVENTION

The use of sales labels, in grocery stores or other establishments, to provide pricing and other information to customers is well-known in the prior art. For a typical grocery store or other retail establishment, the merchandise or goods are arranged in separate groups on shelves. Each shelf has a flat surface on which the goods are placed, and a channel attached to its distal edge. The sales labels, which carry information such as pricing, are positioned in the channel using a mounting device that removably attaches to the sales label or is a part of the sales label. The number of sales labels mounted on a channel depends on the different groups of goods that are placed on a particular shelf. Since multiple sales labels can be inserted in the same channel, the sales label, once inserted, must not slide relative to the products with which it is associated. If sliding were to be permitted, the sales label could be associated with a different group of products and mislead consumers. Consequently, a reliable mounting and locking mechanism is required to anchor the sales label to the channel.

Channels are typically formed of extruded metal sections and sheet metal. The channels often vary in width and, as a result, each store could have different channel sizes all of which have to be fitted with appropriate sales labels. To meet this requirement, sales label manufacturers often provide many different types of mounting mechanisms. Even with a wide assortment of mounting mechanisms, it is frequently necessary to install new extruded metal or plastic sections (channels) before the labels can be installed. In addition, the cost of new channel extrusions and the multiplicity of mounting mechanisms are very expensive. Therefore, it is desirable to have a single mounting mechanism which fits a wide variety of channels. In a typical arrangement, the channel ranges from a minimum height of 1.05 inches to a maximum of 1.25 inches.

Other desirable characteristics for a device for mounting sales labels are easy installation and removal of the device from the channel, low cost, no requirement for a separate tool for installation and removal, and reduction or removal of any damage to the shelves during installation and removal. Applicant believes there is no invention that provides all of the above described desirable characteristics and all existing devices have one or more of the above identified limitations. Hence, there is a clear need for such device for mounting sales labels that remedies all of the above limitations.

### SUMMARY OF THE INVENTION

The present invention is directed to a device for mounting sales labels onto a channel of a shelving system, and that is what is learned by the practice of the subject matter disclosed herein.

In one broad aspect of the invention, a device for mounting sales labels onto a channel of a shelving system comprising a label housing unit; one or more spring-loaded attachment legs; and a lever, wherein the device may be in a first disengaged position where the device may be easily mounted and slide across a channel of the shelving system and a second engaged position where the device is locked in place on the channel.

The foregoing may cover only some of the aspects of the invention. Other and sometimes more particular aspects of the invention will be appreciated by reference to the following description of at least one preferred mode for carrying out the invention in terms of one or more examples. The following mode(s) for carrying out the invention are not a definition of the invention itself but are only example(s) that embody the inventive features of the invention.

### BRIEF DESCRIPTION OF THE DRAWINGS

At least one mode for carrying out the invention in terms of one or more examples will be described by reference to the drawings thereof in which:

FIG. 1 is a perspective view of an embodiment of a device for mounting sales labels onto a shelf, such as a grocery store shelf.

FIG. 2 is a perspective view illustrating the top, back and side views of the device shown in FIG. 1.

FIG. 3 is an exploded perspective view illustrating the top, font and side views of the device shown in FIG. 1.

FIG. 4a is a front elevation view of the device shown in FIG. 1 in a disengaged position.

FIG. 4b is a back elevation view of the device shown in FIG. 1 in the disengaged position.

FIG. 5a is a front elevation view of the device shown in FIG. 1 in an engaged position.

FIG. 5b is a back elevation view of the device shown in FIG. 1 in the engaged position.

FIG. 6a is a side elevation view of the device shown in FIG. 1 in the disengaged position.

FIG. 6b is a side elevation view of the device shown in FIG. 1 in the disengaged position;

FIG. 7a is a side elevation view of the device shown in FIG. 1 in the engaged position;

FIG. 7b is a side elevation view of the device shown in FIG. 1 in the engaged position;

FIG. 8a is a top, front, side perspective view of an embodiment of the device shown in FIG. 1 with an electronic sales label attached to the device.

FIG. 8b is a top, back, side perspective view of an embodiment of the device shown in FIG. 1 with an electronic sales label attached to the device.

FIG. 9 is a top, front, side perspective view of an embodiment of the device shown in FIG. 1 mounted on a channel of a shelving system.

FIG. 10a is a side elevation view of the device shown in FIG. 1 mounted on a channel of a shelving system in the disengaged position.

FIG. 10b is a side elevation view of the device shown in FIG. 1 mounted on a channel of a shelving system in the engaged position.

FIG. 11 is a front elevation view of an attachment member on a channel of a shelving system.

FIG. 12a is a side elevation view of the attachment member shown in FIG. 11 on a channel of a shelving system in a disengaged position.

FIG. 12b is a side elevation view of the attachment member shown in FIG. 11 on a channel of a shelving system in an engaged position.

FIG. 13a is a top, front and side perspective view of the attachment member shown in FIG. 11 on a channel of a shelving system in the disengaged position.

FIG. 13b is a top, front and side perspective view of the attachment member shown in FIG. 11 on a channel of a shelving system in the engaged position.

FIG. 14a is a bottom, front and side perspective view of the attachment member shown in FIG. 11 on a channel of a shelving system in the disengaged position.

FIG. 14b is a bottom, front and side perspective view of the attachment member shown in FIG. 11 on a channel of a shelving system in the engaged position.

FIG. 15a is a side elevation view of the attachment member shown in FIG. 11 on a channel of a shelving system in the engaged position with the device shown in FIG. 1 attached thereto in the disengaged position.

FIG. 15b is a side elevation view of the attachment member shown in FIG. 11 on a channel of a shelving system in the engaged position with the device shown in FIG. 1 attached thereto in the engaged position.

### DETAILED DESCRIPTION OF THE INVENTION

The present invention is a device for mounting sales labels onto existing shelving systems.

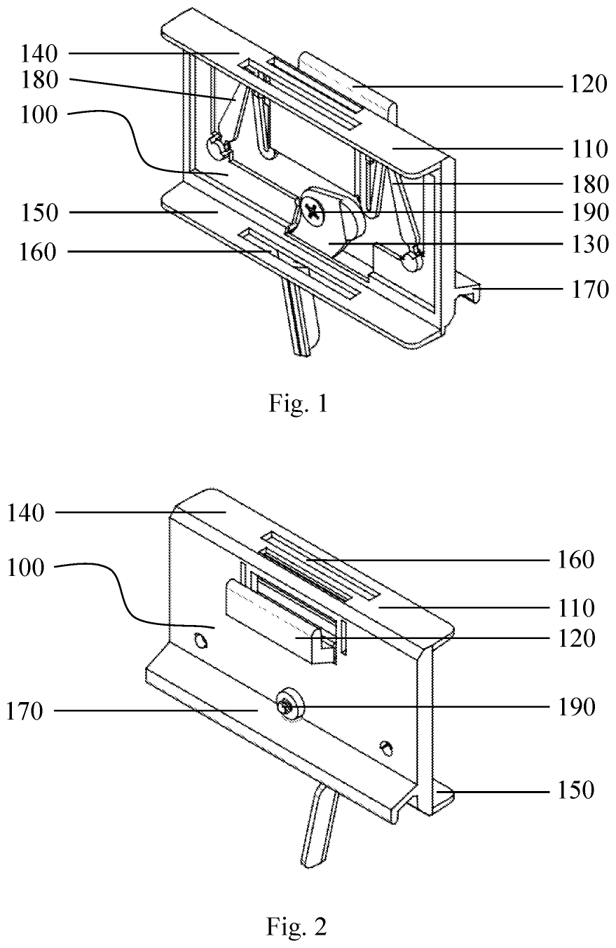

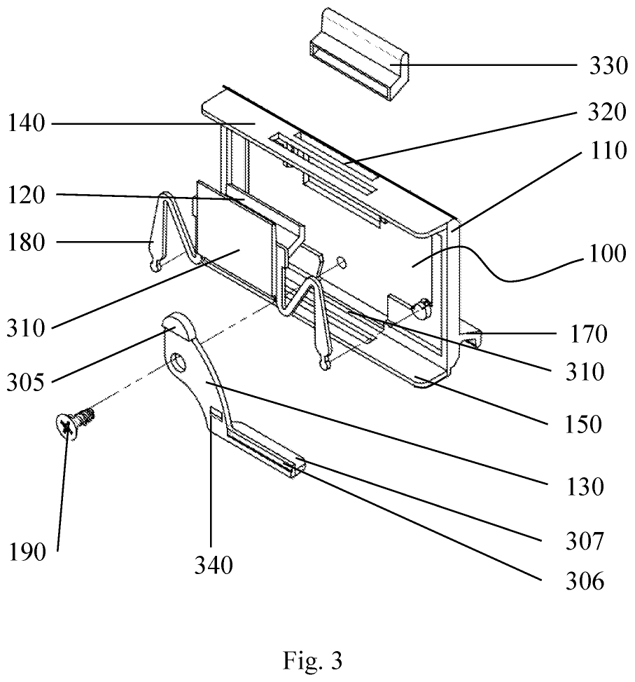

With reference to FIGS. 1-3, an embodiment of the invention of a device for mounting sales labels is shown. In this embodiment, a device 100 comprises a label housing unit 110, a spring-loaded attachment legs 120, and a lever 130.

In an embodiment of the invention, the label housing unit 110 may further comprise an upper member 140 and a lower member 150 that holds the sales label. The upper member 140 and the lower member 150 may each further comprise a recess 160 that allows the device 100 to clip onto the sales label.

In an embodiment of the invention the device 100 may be permanently attached to the sales label.

In an embodiment of the invention, the device 100 may comprise the spring-loaded attachment leg and a fixed attachment leg 170. The spring-loaded attachment leg 120 may comprise one or more springs 180. The springs 180 allow the spring-loaded attachment leg 120 to move between engaged and disengaged positions. The springs 180 may be made of any material capable of acting as a spring including but not limited to metals and plastics. The spring-loaded attachment leg 120 may further comprise a back panel 310, which assists in restricting the movement of the spring-loaded attachment leg in a single plane of motion. The top portion of the back panel 310 slides into a secondary recess 320 of the upper member 140 in the engaged position and restricts the spring-loaded attachment leg 120 from moving in other planes of motion. The back panel 310 may also come in contact with the back of the sales label to further keep the movement in a single plane of motion.

In an embodiment of the invention, in the disengaged position, the spring 180 is at equilibrium and the device 100 may easily fit into a channel 900 of a shelving system 910 and easily slide across. In the engaged position, the spring 180 is stretched out and the device 100 is in a fixed position on the channel 900 of the shelving system 910. In other embodiment of the invention, the spring 180 may also be compressed in the engaged position and be at equilibrium in the disengaged position.

In an embodiment of the invention, the device 100 may comprise one or more spring-loaded attachment legs 120. In such embodiment, the distance between the legs facing opposite direction shall be shorter in the disengaged position than such distance in the engaged position.

In an embodiment of the invention, the lever 130 is attached to the device 100 using a screw 190 and the lever 130 is comprised of a push end 305 and a trigger end 306. The lever 130 is attached such that the screw 190 acts as a pivot point for the lever 130. The lower member 150 may further comprise a lever recess 310 that provides enough space for the lever 130 to rotate. The range of rotation of the lever 130 may be limited by the size of the lever recess 310. The lever 130 may further comprise a stopper 340 and a handle 307. The stopper keeps the lever in an engaged position until external force is applied to the trigger end 306 to rotate the lever 130. The handle 307 allows a user to easily flick the lever 130 in either direction to alternate between the disengaged and engaged positions.

In other embodiments of the invention, other mechanical fasteners may be used to attach the lever 130 onto the device 100 including but not limited to rivets, snap-fit features and nuts and bolts.

In an embodiment of the invention, the device 100 may further comprise a spacer 330 that may attach to any type of leg of the device 100. The spacer 330 allows the device 100 to be mounted on shelving systems with larger channels by increasing the distance between the legs. The space 330 may add additional support and prevent the device 100 from sliding across the channel 900 by way of added friction and flexibility in the material used to make the spacer 330. The space 330 may be made of materials including but not limited to rubber, silicone and plastics.

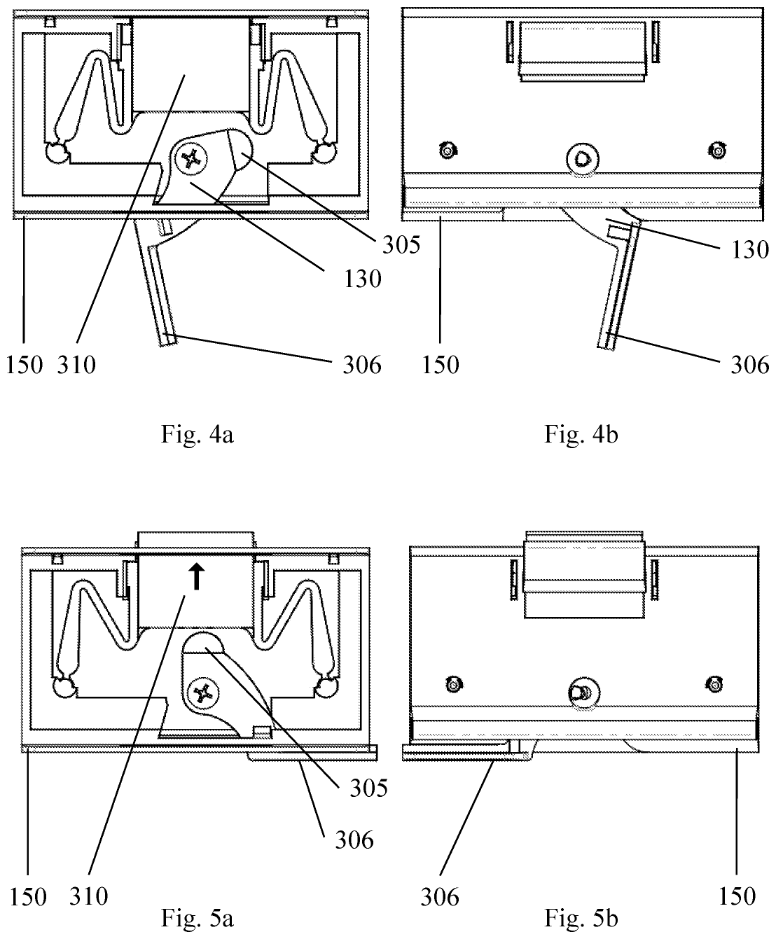

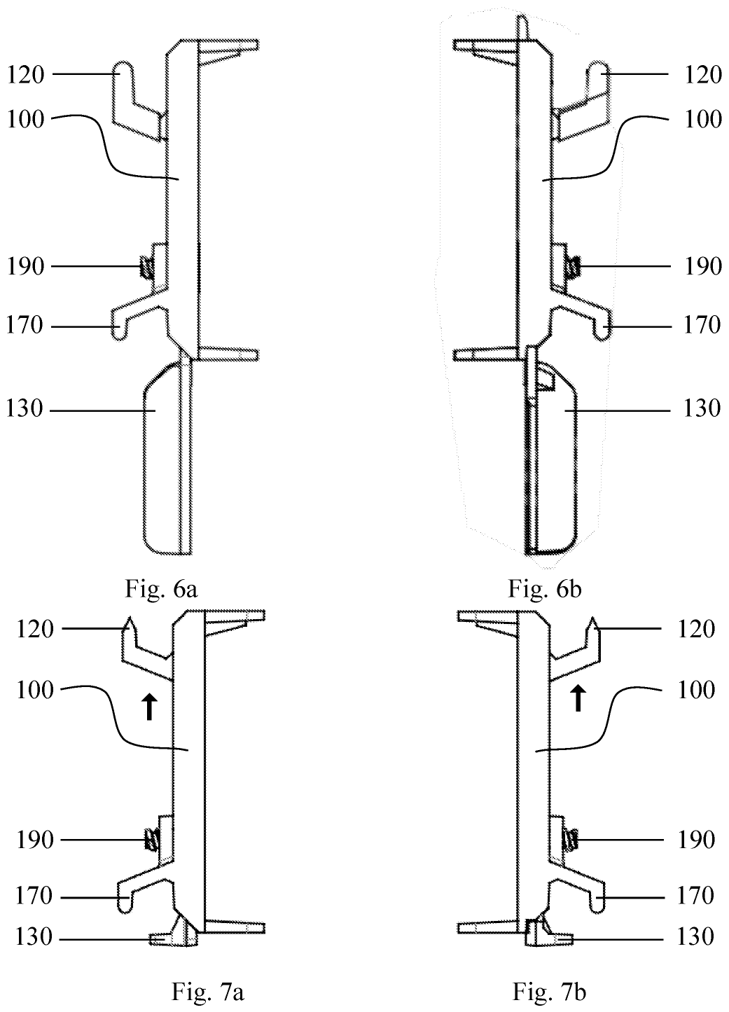

With reference to FIGS. 4-7, the device 100 may be in disengaged and engaged positions. In an embodiment of the invention, FIGS. 4a, 4b, 6a and 6b show the device 100 in the disengaged position. In the disengaged position, the trigger end 306 points downwards relative to the device 100 and the push end 305 is not in contact with the back panel 310. In the disengaged position, the back panel 310 and the spring-loaded attachment leg 120 are positioned at the equilibrium point of the spring 180. In the disengaged position, the device 100 may easily be mounted onto the channel 900 of the shelving system 910 and slide along such channel 900 with ease.

In an embodiment of the invention, FIGS. 5a, 5b, 7a and 7b show the device 100 in the engaged position. In the engaged position, the trigger end 301 is pushed upwards relative to the device 100 and the trigger end 306 and the handle 307 may come in contact with the lower member 150. The push end 305 pushes the spring-loaded attachment leg 120 and the back panel 310 upwards in the direction of the arrow. In the engaged position, the top portion of the back panel 310 slides through the secondary recess 320, which helps keep the device 100 in the engaged position and the movement in one plane of motion. The stopper 340 also helps keep the device 100 in the engaged position by stopping the lever from pivoting without external force pushing down on the trigger end 306. In the engaged position, the device 100 is mounted on the shelving system 910 and fixed in its position on the channel 900.

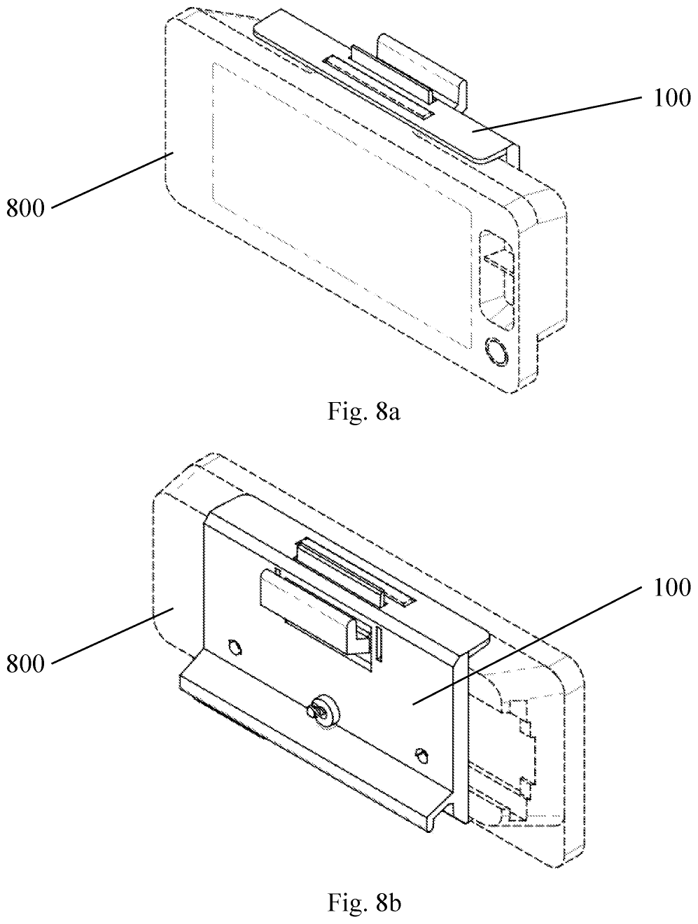

With reference to FIGS. 8a and 8b, an embodiment of the device 100 with an electronic sales label 800 removably attached is shown. The upper member 140 and the lower member 150 clip onto the electronic sales label 800 and keep the electronic sales label 800 on the device 100.

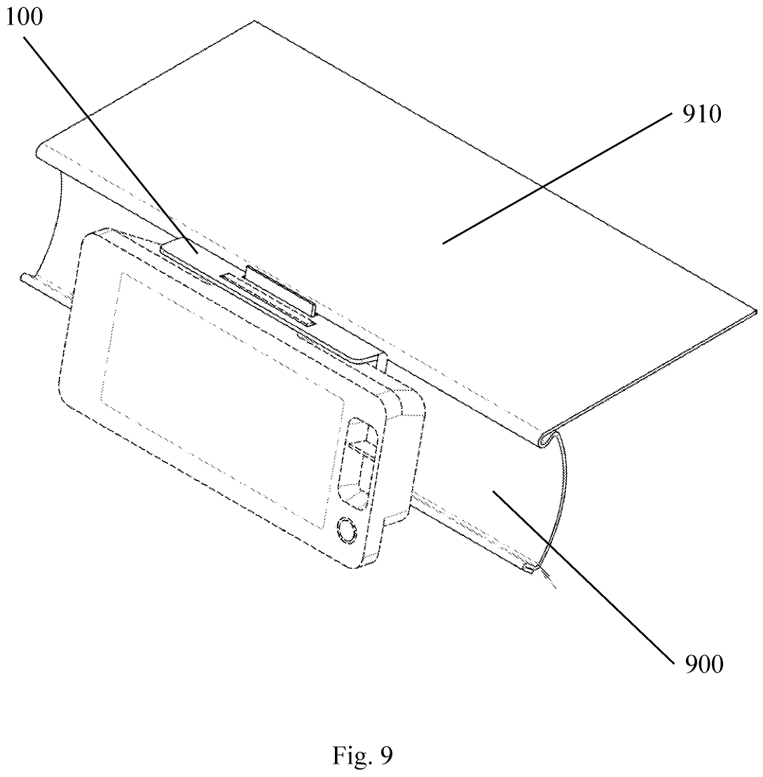

With reference to FIG. 9, the device 100 may be mounted onto the shelving system 910 via the channel 900.

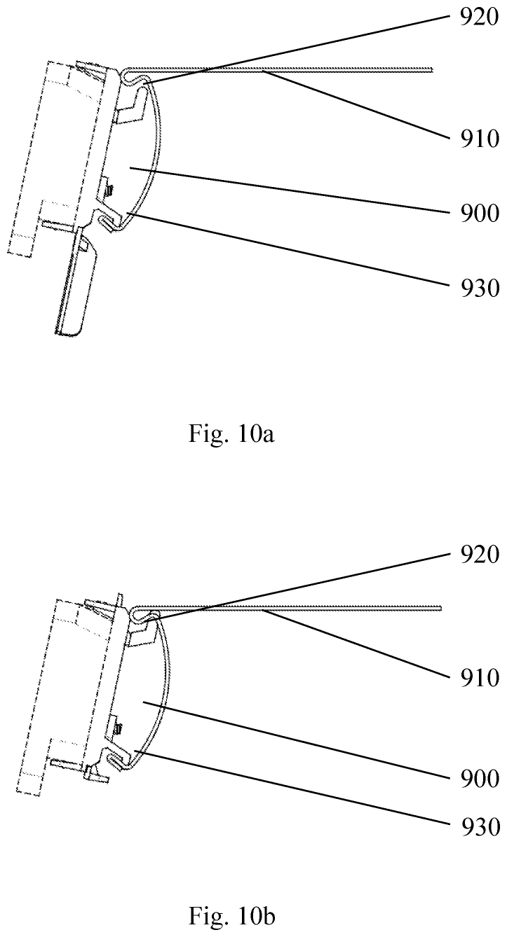

With reference to FIGS. 10a and 10b, in an embodiment of the invention, the fixed leg 170 fits into the bottom edge 930 of the channel 900 and the spring-loaded attachment leg 120 fits into the top edge 920 of the channel 900. In the disengaged position, the device 100 may move along the channel 900 freely as the distance between the top of the spring-loaded attachment leg 120 and the bottom of the fixed leg 170 is less than the height of the channel 900. In the engaged position, the spring-loaded attachment leg 120 is elevated and pushes against the top edge 920 of the channel 900, locking the device 100 in its place on the channel 900.

With reference to FIGS. 10a and 10b, in an embodiment of the invention, the fixed leg 170 fits into the bottom edge 930 of the channel 900 and the spring-loaded attachment leg 120 fits into the top edge 920 of the channel 900. In the disengaged position, the device 100 may move along the channel 900 freely as the distance between the top of the spring-loaded attachment leg 120 and the bottom of the fixed leg 170 is less than the height of the channel 900. In the engaged position, the spring-loaded attachment leg 120 is elevated and pushes against the top edge 920 of the channel 900, locking the device 100 in its place on the channel 900.

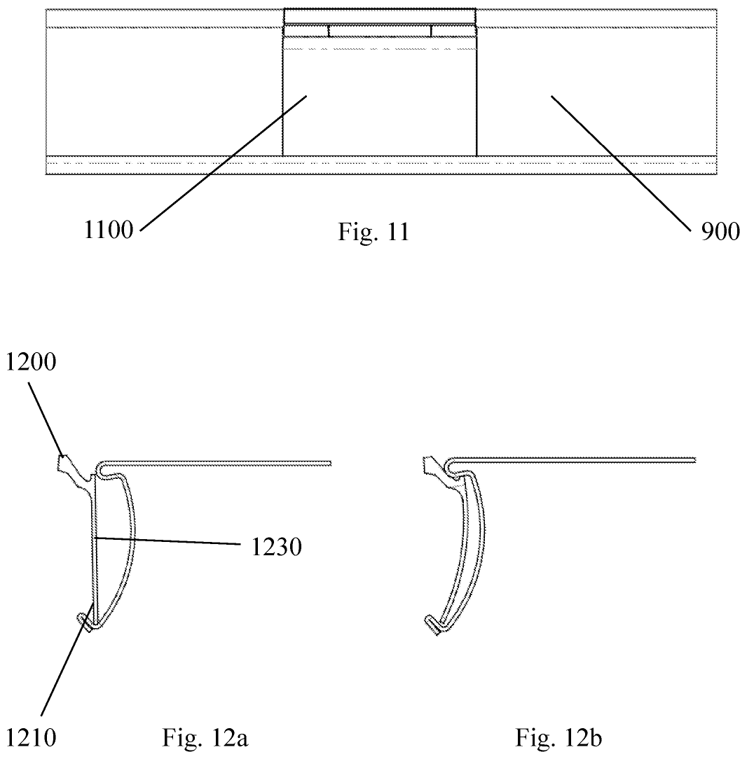

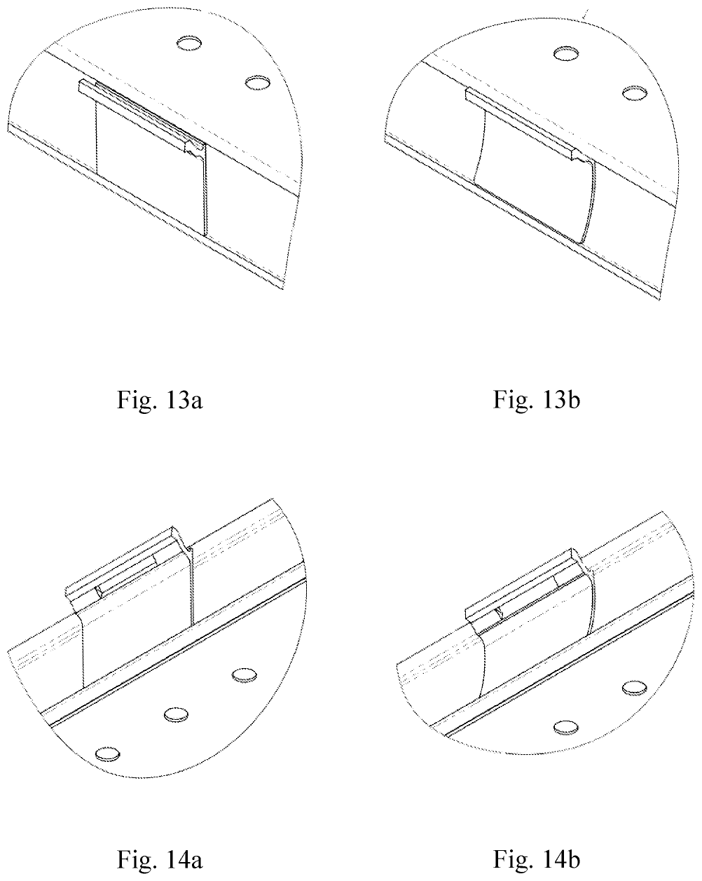

With references to FIG. 11-15, in an embodiment of the invention, an attachment member 1100 is attached onto the channel 900. The attachment member 1100 comprises a grooved end 1200, a flat end 1210 and a body 1230. The attachment member 1100 allows for a more secure attachment of the device 100 onto the channel 900. In a disengaged state of the attachment member 1100, as shown in FIGS. 12a, 13a and 14a, the flat end of the attachment member 1100 is placed in the bottom edge 930 of the channel and the grooved end 1200 rests outside the top edge 920 of the channel 900. In such state, the body 1230 of the attachment member 1100 is flat.

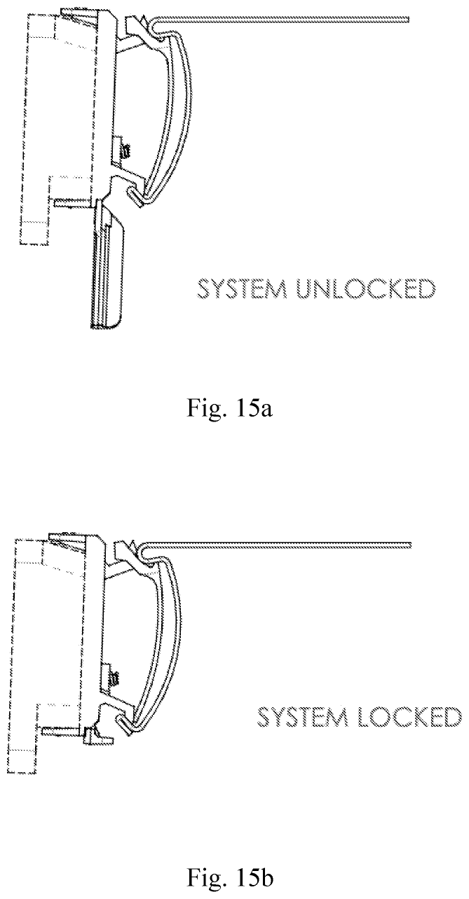

In an engaged state, as shown in FIGS. 12b, 13b, and 14b, the grooved end 1200 is pushed into the channel 900 to fit in the top edge 920 of the channel 900. In such state, the body 1230 of the attachment member 1100 is curved. In references to FIGS. 15a and 15b, the device 100 may then be attached onto the attachment member 1100, which allows for a more secure and stable attachment on the channel 900.

In the foregoing description, exemplary modes for carrying out the invention in terms of examples have been described. However, the scope of the claims should not be limited by those examples but should be given the broadest interpretation consistent with the description as a whole. The 260 specification and drawings are, accordingly, to be regarded in an illustrative rather than a restrictive sense.

1. A device for mounting a sales label onto a shelving system, the device comprising:
a label housing unit;
a spring-loaded attachment leg; and
a lever
wherein the device is operable between a first disengaged position and a second engaged position, and when in the first disengaged position the device is mounted and slid across a channel of the shelving system, and when in the second engaged position the device is locked in place on the channel.

2. The device of claim 1, further comprising a fixed attachment leg.

3. The device of claim 1, further comprising a spacer attached to the spring-loaded attachment leg or the fixed attachment leg.

4. The device of claim 1, wherein the lever comprises a stopper.

5. The device of claim 1, wherein the lever comprises a push end and a trigger end.

6. The device of claim 1, wherein the spring-loaded attachment leg comprises a back panel to restrict the movement of the spring-loaded attachment leg in a single plane of motion.

7. The device of claim 1, wherein the device further comprises a lever recess that restricts the range of motion of the lever.

8. The device of claim 1, wherein the spring-loaded attachment leg further comprises a spring.

9. The device of claim 1, wherein the device further comprises an attachment member with in the channel of the shelving system.

10. A device for mounting a sales label onto a shelving system, the device comprising
a label housing unit;
a spring-loaded attachment leg;
a fixed leg; and
a lever
wherein the device is in
a first disengaged position where the device is mounted and slideable across a channel of the shelving system and
a second engaged position where the device is locked in place in the channel.

11. The device of claim 10, further comprising a spacer removably attached to the spring-loaded attachment leg or the fixed attachment leg.

12. The device of claim 10, wherein the lever comprises a stopper.

13. The device of claim 10, wherein the lever comprises a push end and a trigger end.

14. The device of claim 10, wherein the spring-loaded attachment leg comprises a back panel to restrict movement of the spring-loaded attachment leg in a single plane of motion.

15. The device of claim 10, wherein the device further comprises a lever recess that restricts range of motion of the lever.

16. The device of claim 10, wherein the spring-loaded attachment leg further comprises a spring.

17. The device of claim 10, wherein the device further comprises an attachment member within the channel of the shelving system.
